(19) United States
(12) Patent Application Publication
(10) Pub. No.: US 2010/0235257 A1
(43) Pub. Date: Sep. 16, 2010

(54) Multimedia gift registry system

(75) Inventors: Antoine Bentue-Ferrer, le Kremlin Bicetre (FR); Mathieu Germain, Guyancourt (FR); Arnaud Krief, Villepinte (FR); Timothy Scala, North Bergen, NJ (US); Emmanuel Botros Youssef, Sucy En Brie (FR)

Correspondence Address: BRENDA POMERANCE;LAW OFFICE OF BRENDA POMERANCE, 310 West 52 Street, Suite 27B, NEW YORK, NY, 10019, US

(73) Assignee: From Me Productions, LLC, Bloomfield, NJ (US)

(21) Appl. No.: 12/311,845

(22) PCT Filed: Oct. 15, 2007
(86) PCT No.: PCT/US2007/021988

§ 371 Date: Apr. 15, 2009

Related U.S. Application Data
(60) Provisional application No. 60/851,970, filed on Oct. 16, 2006.

(51) Int. Cl. G06Q 30/00; G06F 15/16

(52) U.S. Cl. 705/27; 709/203

(57) ABSTRACT

Electronic purchasing is facilitated by enabling an initiator to upload a multimedia file created by the initiator, along with a personal text message. The multimedia file enables enhanced personalization of communication between the initiator and the responder. The initiator schedules sending of notice of the uploaded multimedia file to a responder, with either a gift for the responder or a wish list of items so that the responder can pick a gift for the initiator. A purchase order for the gift is provided to a merchant, the purchase order being from either the initiator or the responder.

This application is a national stage of PCT patent application PCT/U.S. Ser. No. 07/21988, filed Oct. 15, 2007, which claims priority from U.S. provisional patent application Ser. No. 60/851,970, filed Oct. 16, 2006.

### BACKGROUND OF THE INVENTION

The present invention relates to a website for facilitating e-commerce, and more particularly, is directed to a website that enables uploading and storage of user-produced files, viewing of wish lists for gifts and purchasing of gifts.

A conventional gift registry is a list of items that a recipient wishes to receive, typically maintained by a seller of such items at no overt cost to the recipient or givers. When an item on the list is purchased, the registry so indicates, to avoid duplicate gifts given to the recipient. The benefit to the seller is clear: the list stimulates buyers to make purchases from the seller.

Online gift registries enable buyers to view images of the items on a recipient's list, typically helping the buyer decide which of the desired gifts to give based on the buyer's reaction to the image.

However, there is room for improvement in gift registry systems.

### SUMMARY OF THE INVENTION

In accordance with an aspect of this invention, there are provided a method of and a system for facilitating electronic purchases. The following are accepted: (i) an uploaded multimedia file from an initiator, the multimedia file including at least one of audio, full motion video, image and graphic data, (ii) a personal text message from the initiator, (iii) information identifying at least one responder, (iv) information specifying the date and time when the at least one responder is to be notified of the availability of the multimedia file, and (v) a selection of at least one item available for purchase from a merchant. At the specified date and time, the at least one responder is notified of the availability of the uploaded multimedia file, and sent the personal text message. A purchase order for the selected item is accepted, and provided to the merchant.

In some aspects of the invention, the purchase order is from the initiator, and the further comprising sending a purchase confirmation notice to the initiator. In other aspects of the invention, the purchase order is from the responder, and further comprising sending a purchase confirmation notice to the responder.

In some aspects of the invention, the uploaded multimedia file is encoded into a target format.

In some aspects of the invention, the merchant executes software for outsourcing the facilitating of electronic purchases to a third party, the third party being controlled by other than the merchant.

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1 is a block diagram showing a first physical environment for the present invention;

FIG. 2A-2D are a flowchart showing how information is exchanged according to the present invention; and

FIG. 3 is a block diagram showing a second physical environment for the present invention.

### DETAILED DESCRIPTION

Electronic purchasing is facilitated by enabling an initiator to upload a multimedia file created by the initiator, along with a personal text message. The multimedia file enables enhanced personalization of communication between the initiator and the responder, which in turn enhances the emotional value of a purchase connected with the enhanced communication. The initiator schedules sending of notice of the uploaded multimedia file to a responder, with either a gift for the responder or a wish list of items so that the responder can pick a gift for the initiator. A purchase order for the gift is provided to a merchant, the purchase order being from either the initiator or the responder. The merchant fulfills the purchase order.

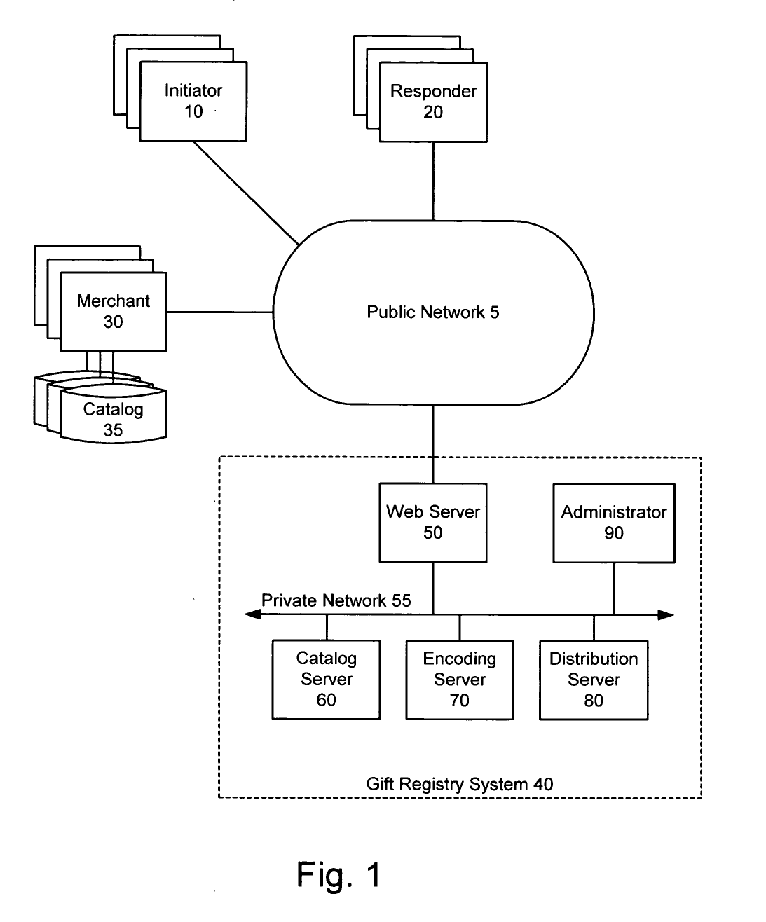

Referring now to the drawings, and in particular to FIG. 1, there is illustrated a computer and communication block diagram.

Public network 5 is a communication network accessible through wireline and/or wireless communication channels, that enables information to be transmitted between entities connected thereto. An example of public network 5 is the Internet.

Initiator 10, responder 20, merchant 30 and gift registry 40, also referred to as entities, are general purpose computers programmed to operate according to the present invention, and having suitable wireline and/or wireless communication capabilities. Each of the entities is configured to communicate via public network 5. There may be multiple instances of each type of entity, e.g., hundreds of initiators 10, thousands of responders 20, and millions of merchants 30. In some cases, a human may be both an initiator and a responder, although in different transactions.

In some embodiments, there is one gift registry 40 that communicates with all instances of merchants 30. In other embodiments, gift registry 40 is a component of merchant 30, and operates for only merchandise offered by that instance of merchant 30. In yet other embodiments, gift registry 40 manifests as a hybrid of a single centralized system with components distributed to selected instances of merchants 30.

In the discussion below, initiator 10 and responder 20 are assumed to be personal devices, such as a personal computer or handheld device, having sufficient processing power to execute software that presents information to a user via text, graphics, static images, moving images (video), and audio. The software is generally referred to as a web browser.

Merchant 30 is assumed to be a server computer, that is, a computer programmed to accept requests from public network 5 in a format such as hypertext transfer protocol and to respond to the requests. Merchant 30 executes server software that operates according to a stored program to provide its responses in the form of web pages, either static pages such as a home page, or dynamically created pages such as a shopping cart page. Merchant 35 has local storage 35 including its catalog of items offered for sale.

Gift registry 40 comprises private network 55, and web server 50, catalog server 60, encoding server 70, distribution server 80 and administrator 90, each of which is a general purpose computer programmed to operate according to the present invention and is configured to communicate via private network 55. Web server 50 is also configured to communicate via public network 5. Catalog server 60, encoding server 70 and distribution server 80 may each be implemented as a plurality of processors in one or more physical locations, with new work generally assigned to the least busy server.

A human uses initiator 10 to provide a message in a multimedia format to gift registry 40, and either a designation of who the message should be sent to accompanied by a gift, or a designation of who the message should be sent to accompanied by a wish list of gifts. In turn, gift registry 40 converts the multimedia message to a target format, optionally reviews the multimedia message for acceptability, then delivers notice of the multimedia message to the intended addressee at the appropriate time. Each addressee is able to view the multimedia message, and either receives an accompanying gift or can view a wish list and select a gift from the wish list for purchase. Gift registry 40 passes the purchase request to merchant 30; which fulfills the request. Suitable notices are sent to initiator 10 and responder 20, and the wish list is adjusted to reflect the purchase.

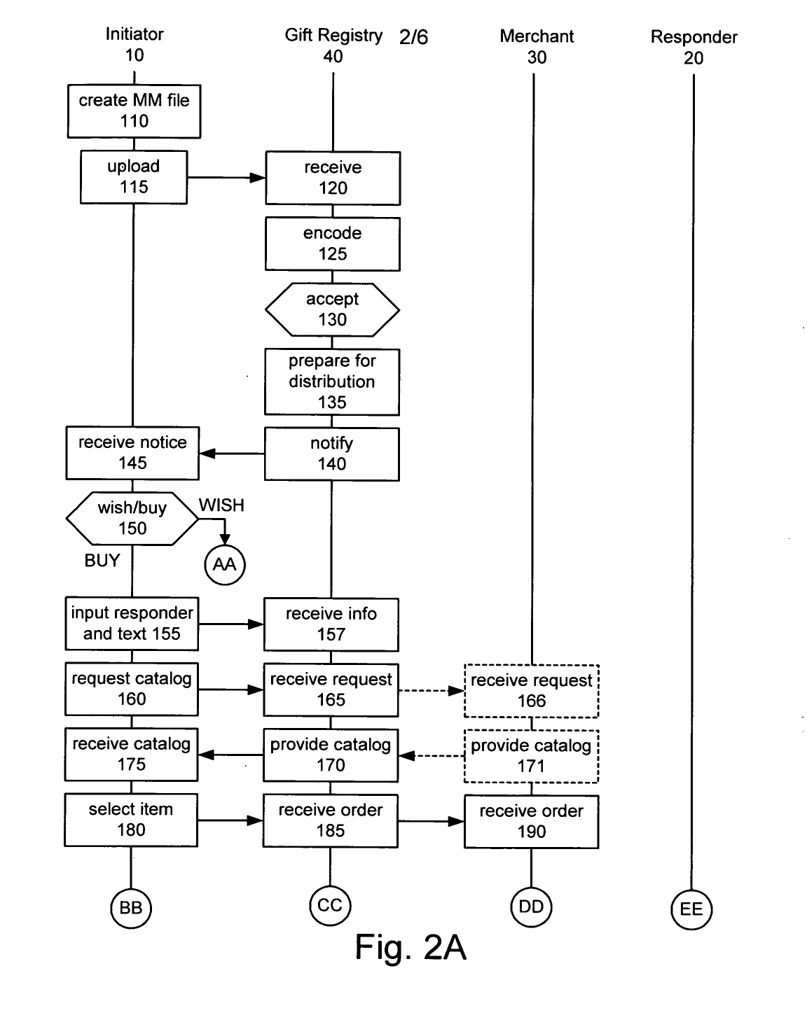

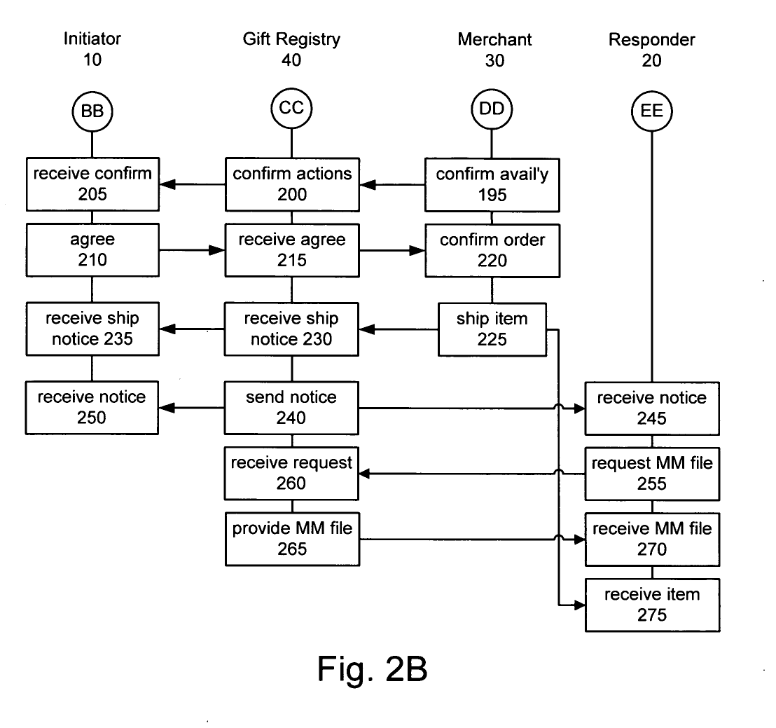

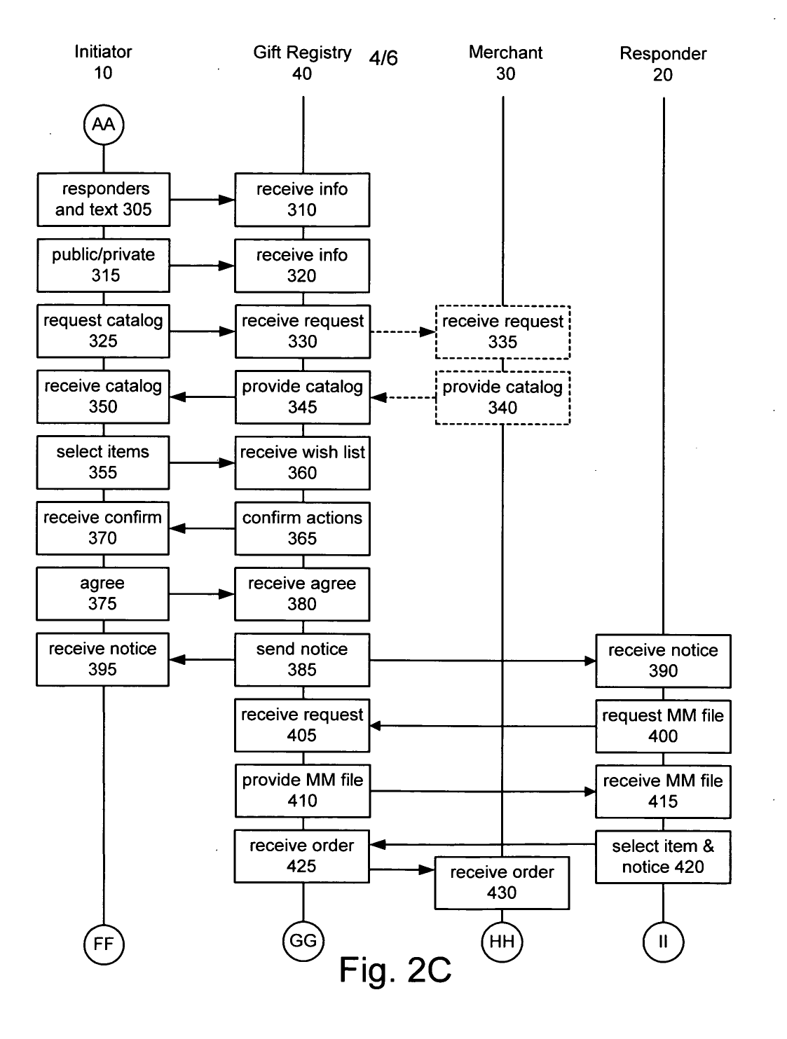

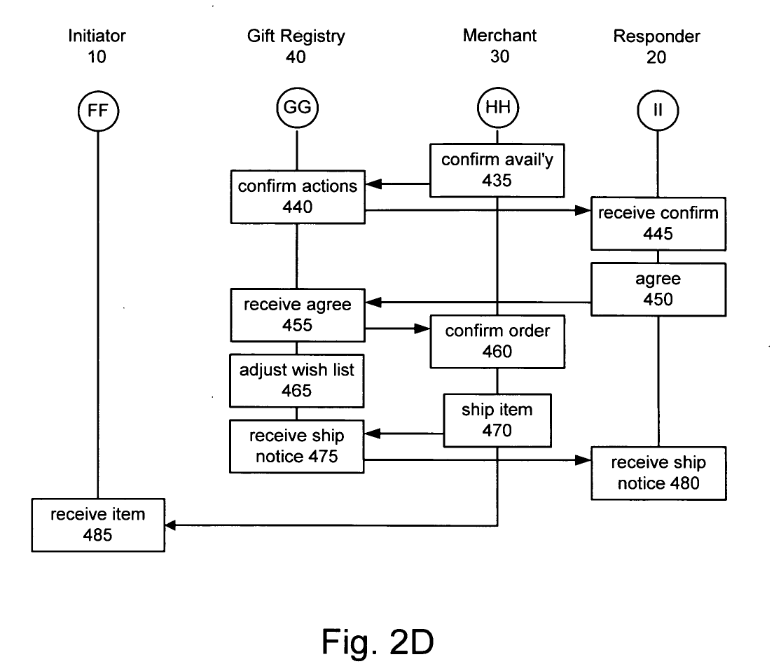

FIGS. 2A-2D, collectively referred to as FIG. 2, form a flowchart providing details of the operation of the preceding paragraph. Unless otherwise specified, the functionality of gift registry 40 is provided by web server 50.

During a registration step (not shown), initiator 10 registers with gift registry 40 by creating a profile, including information such as a registry name, registry password, actual name, email address, telephone number, and ship-to address. Table 1 shows a profile record.

TABLE 1
Profile Record

registry name
registry password
actual name
email address
telephone number
ship-to address
date and time profile created
date and time profile last updated

At step 110, initiator 10 creates a multimedia file, serving as a personal message from the initiator to others. As used herein, “multimedia file” refers to a file containing audio and/or full motion video and/or an image and/or a graphic. For example, the multimedia file might be a one minute segment showing the initiator's dog doing a cute acrobatic move, accompanied by audio of the dog barking.

At step 115, initiator 10 uploads the multimedia file to gift registry 40. At step 120, gift registry 40 receives the file.

At step 125, gift registry 40 encodes the file into a target format. More specifically, gift registry 40 provides a player for playing stored multimedia files, such as a proprietary Streamplug player that plays files in .ogg format. Ogg is the name of Xiph.org's container format for audio, video, and metadata. Vorbis is the name of a specific audio compression scheme designed to be contained in Ogg. Video files are encoded in H.264 format. However, other formats are also suitable. Encoding server 70 performs the encoding. While encoding, the bandwidth of the signal may be altered to not exceed the target rate for gift registry 40, such as 300 kbps. In some embodiments, encoding includes selecting a thumbnail image to represent the multimedia file.

At step 130, which is optional, administrator 90 reviews the encoded file to ensure acceptability. For example, pornographic, hateful or apparently unpermitted use of other's images may be reasons for deeming the encoded file to be unacceptable. If unacceptable, a notice is sent to initiator 10, the encoded file is deleted and processing terminates.

At step 135, gift registry 40 prepares the encoded file for distribution, such as by storing it on distribution server 80.

At step 140, gift registry 40 notifies initiator 10 that the multimedia file has been accepted and is ready for viewing.

At step 145, initiator 10 receives the acceptance notice.

At step 150, initiator 10 decides whether to create a gift list, and processing continues at step 305, or to select an item to accompany the multimedia file, in which case processing continues at step 155.

At step 155, initiator 10 provides:
the email address of a party who should be notified of availability of the multimedia file, such as “myspouse@domain.com”,
a date and time when the notice should be received, an accompanying text message, such as, “Doggie and I wish you a happy birthday, and look forward to your return from your trip”,
a name and physical address to which the gift should be delivered,
a date and possibly time that the item should be delivered, or a date by which the item must be shipped, and
payment information, such as a credit card or payment service authorization.
   At step 157, gift registry 40 receives the scheduling data, address and text message, and stores this information.

At step 160, initiator 10 requests a catalog of items available for purchase. More specifically, initiator 10 can request a subset of items by one or more of keyword, merchant name, price, popularity, newness, and product name.

At step 165, gift registry 40 receives the catalog (or subset) request. In one embodiment, at step 170, gift registry 40 retrieves appropriate information from its catalog server 60, and provides the retrieved information to initiator 10. In another embodiment, step 170 serves as a pass-through step, wherein gift registry 40 passes the catalog request to merchant 30, and at step 171, merchant 30 retrieves appropriate information from its catalog database 35, and then at step 170, gift registry 40 passes the information to initiator 10. In yet another embodiment, information for certain items is retrieved from catalog server 60 at gift registry 40, while information for other items—such as items requested from merchant 30 or available only from merchant 30—is retrieved from catalog database 35 at merchant 30.

At step 175, initiator 10 receives the requested catalog information, typically a combination of text and image information, but graphics, audio and full-motion video may also be used. Initiator 10 may browse the catalog, or request additional catalog information.

At step 180, initiator 10 selects an item from the catalog, as a gift for the addressee.

At step 185, gift registry 40 receives the item order, and passes it to merchant 30.

At step 190, merchant 30 receives the item order. At step 195, merchant 30 confirms availability of the item for shipment so that it arrives at the desired time, or is shipped within a particular timeframe.

At step 200, gift registry 40 receives the merchant's confirmation, and prepares a full recitation of the actions to be taken, such as send the notice of multimedia file availability, and deliver the item, with date, time and destination details, and sends the full recitation to initiator 10.

At step 205, initiator 10 receives the full recitation of actions to be taken. At step 210, initiator 10 agrees that these actions are correct, such as by clicking a “do it” or “buy it” button.

At step 215, gift registry 40 receives initiator 10's agreement, and sends a confirmation to merchant 30. At step 220, merchant 30 receives the confirmation.

At a suitable time, at step 225, merchant 30 ships the item, and sends a shipping notice to gift registry 40.

At step 230, gift registry 40 receives the shipment notice and forwards it to initiator 10. At step 235, initiator 10 receives the shipment notice.

Then, at the appointed time, at step 240, gift registry 40 sends notice of the availability of the multimedia file to the addressee, such as via an email with a hyperlink and the text message, and confirms to initiator 10 that the notice was sent.

At step 245, the addressee, assumed to be responder 20, receives the email message.

At step 250, initiator 10 receives notice that the respondent 20 was notified of the multimedia file.

At step 255, responder 20 requests the multimedia file, such as by clicking on the hyperlink in the email.

At step 260, gift registry 40 receives the request, and at step 265, gift registry 40 provides the requested file to responder 20.

At step 270, responder 20 receives the multimedia file and views/listens to the file.

At step 275, responder 20 receives the item from merchant 30. This completes use of gift registry 40 to send a personal multimedia greeting and an item.

Use of the wish list facility of gift registry 40 will now be discussed.

At step 305, initiator 10 provides:
the email addresses of at least one party who should be notified of availability of the multimedia file, also referred to as a gift giver list,
a date and time when the notice should be received, an accompanying text message, such as, “Doggie is happy that her birthday is coming up!”,
a name and physical address to which gifts should be delivered, and
optionally, a date and possibly time that gifts should be delivered.
   For each entry, the gift receiver can provide a personal message. Table 2 shows an exemplary gift giver list format.

TABLE 2
Gift Giver List

registry name of creator
name of wish list
name of gift giver list
date and time gift giver list created
date and time gift giver list updated by
creator
gift giver entry 1
gift giver entry 2
gift giver entry 3

Table 3 shows an exemplary gift giver entry record.

TABLE 3
Gift Giver Entry

registry name of creator
name of wish list
name of gift giver list
email address
personal message

In one embodiment, gift registry 40 provides a small software program to initiator 10, which guides the gift receiver through creating the gift giver list. In some cases, the small software program works with a pre-existing program, such as Microsoft Outlook or Google Gmail, to enable the gift receiver to more conveniently select email addresses.

At step 310, gift registry 40 receives the information.

At step 315, initiator 10 indicates whether the to-be-specified wish list should be public or private. At step 320, gift registry 40 receives the selection of public or private.

Steps 325, 330, 335, 340, 345, 350, are similar to steps 160, 165, 166, 171, 170, 175, respectively, and are not described again for brevity.

At step 355, initiator 10 selects items for a new wish list. At step 360, gift registry 10 receives the wish list. After an item is included on a wish list, it can be annotated with a personal text message intended for all viewers of the list, or only one or more selected viewers of the list. Table 4 provides an exemplary format for a wish list.

TABLE 4
Wish List

registry name of creator
name of wish list
date and time wish list created
date and time wish list expires
date and time wish list updated by creator
date and time wish list updated by registry
wish list item 1
wish list item 2
wish list item 3

Table 5 provides an exemplary format for a wish list item record.

TABLE 5
Wish List Item

registry name of creator
name of wish list
date and time wish list item added
quantity of item desired
date and time wish list item purchased
purchaser identifier
merchant identifier
purchase confirmation identifier
item identifier
item text name
thumbnail pointer
additional file(s) pointer(s)
personal text message
access list for personal text message

At step 365, gift registry 10 prepares a message confirming the actions to be taken, such as, “On date/time, we will send a notice to (gift giver list), with a personal message of” xx “advising that your multimedia file is available, and your wish list is available. Items purchased from your wish list will be sent to (address)”, and sends the message to initiator 10.

At step 370, initiator 10 receives the confirming message. At step 375, initiator 10 agrees to the actions.

At step 380, gift registry 40 receives agreement from initiator 10. Table 6 shows a profile record updated with the presence of a wish list and associated gift giver list.

TABLE 6
Profile Record

registry name
registry password
actual name
email address
telephone number
ship-to address
date and time profile created
date and time profile last updated
wish list name 1
gift giver list name 1

At any time until the wish list expires, initiator 10 can update the wish list and/or the associated gift giver list. Updating refers to adding, subtracting or changing information.

At step 385, if public (see step 315), gift registry 40 adds the wish list to the searchable index of wish lists. The wish list can be searched by a thumbnail representing the multimedia file accompanying the wish list, by keywords in the wish list, by name or email address of the wish list creator, or by other characteristics. Gift registry 40 also sends a hyperlink to the gift giver list.

At step 385, if private (see step 315), then gift registry 40 sends a hyperlink with a code, equivalent to a password, to the gift giver list, such as “www.giftregistry.com/wishlist_initiator10/codeAgh54rsx”. The purpose of the code is to decrease the likelihood that a visitor not on the gift giver list will be able to guess the hyperlink corresponding to the wish list.

At step 390, responder 20, assumed to be on the gift giver list, receives notice of availability of the multimedia file and wish list. At step 400, responder 20, requests the multimedia file. At step 405, gift registry 40 receives the request for the multimedia file, and at step 410, gift registry 40 provides the multimedia file and wish list. At step 415, responder 20 receives the requested multimedia file and wish list.

At step 420, responder 20 selects an item for purchase, specifies a payment method, decides the type of notice to be sent to initiator 10—such as none/anonymous/named giver—and sends the selection to gift registry 40.

At step 425, gift registry 40 receives the selection of the item, and passes the selection to merchant 30.

At step 430, merchant 30 receives responder 20's selection of an item.

At step 435, merchant 30 confirms availability of the item.

At step 440, gift registry 440 receives confirmation of the availability and prepares a confirmation message stating that the item will be purchased, and delivered at the specified time, with or without notice of the purchase, with payment as specified, and sends the confirmation message to responder 20.

At step 445, responder 20 receives the confirmation message, and at step 450, responder 20 agrees to the actions in the confirmation message.

At step 455, gift registry 40 receives responder 20's agreement, and sends confirmation to merchant 30. At step 460, merchant 30 receives the order confirmation.

At step 465, gift registry 40 adjusts the wish list to reflect that the item has been purchased.

At step 470, merchant 30 ships the item, and sends notice of the shipment to gift registry 40.

At step 475, gift registry 40 receives notice of the shipment, and forwards the notice to responder 20.

At step 480, responder 20 receives notice of the shipment.

At step 485, initiator 10 receives the item.

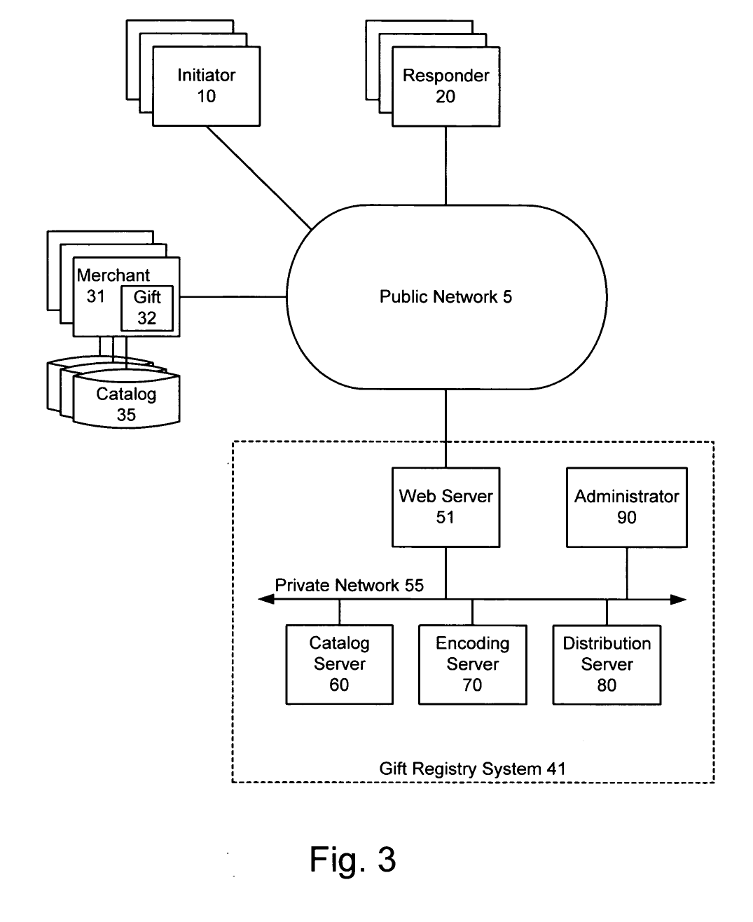

FIG. 3 shows another embodiment of the present invention. The configuration of FIG. 3 is similar to that of FIG. 1; for brevity, only differences are discussed. Generally, the configuration of FIG. 3 presents the functionality of gift registry 41 as if it were local to merchant 31, that is, initiator 10 believes interaction is occurring directly with merchant 31.

It is well-known for websites to outsource the functionality of an electronic shopping cart, so that a website user believes the shopping cart is being operated from the website whereas, in fact, the shopping cart functionality is being provided by a third party website, in a manner which appears that the original website is providing the functionality. Similarly, in FIG. 3, the functionality of a gift registry as discussed above appears to be provided locally by merchant 31, but it is in fact outsourced to gift registry 41, which provides the gift registry functionality in a manner which appears that merchant 31 is providing the functionality.

Merchant 31 obtains gift software 32 from gift registry 41, and installs gift software 32 locally, providing suitable icons and descriptive web pages so that initiator 10 believes a gift registry is available at merchant 31. However, when initiator 10 uploads its personally created multimedia file, personal text message, gift giver list and so on, as described with respect to FIG. 2, the information is actually directed to gift registry 41. Similarly, when responder 20, assumed to be on a gift giver list, requests a multimedia file or wish list, the request is fulfilled by gift registry 41.

Although illustrative embodiments of the present invention, and various modifications thereof, have been described in detail herein with reference to the accompanying drawings, it is to be understood that the invention is not limited to these precise embodiments and the described modifications, and that various changes and further modifications may be effected therein by one skilled in the art without departing from the scope or spirit of the invention as defined in the appended claims.

What is claimed is:

1. A system for facilitating electronic purchases, comprising:
a server, comprising at least one computer, for accepting (i) an uploaded multimedia file from an initiator, the multimedia file including at least one of audio, full motion video, image and graphic data, (ii) a personal text message from the initiator, (iii) information identifying at least one responder, (iv) information specifying the date and time when the at least one responder is to be notified of the availability of the multimedia file, and (v) a selection of at least one item available for purchase from a merchant,
a communication channel for notifying, at the specified date and time, the at least one responder of the availability of the uploaded multimedia file, and for sending the personal text message to the responder at the specified date and time,
the server also for accepting a purchase order for the selected item, and
the server also for providing the purchase order to the merchant.

2. The system of claim 1, wherein the purchase order is from the initiator, and the server is also for sending a purchase confirmation notice to the initiator.

3. The system of claim 1, wherein the purchase order is from the responder, and the server is also for sending a purchase confirmation notice to the responder.

4. The system of claim 3, wherein the server is also for sending the selection of at least one item to the responder.

5. The system of claim 1, further comprising an encoding server for encoding the uploaded multimedia file into a target format.

6. The system of claim 1, further comprising a distribution server for storing the uploaded multimedia file and for providing the uploaded multimedia file to the responder.

7. The system of claim 1, wherein the merchant executes software for outsourcing the facilitating of electronic purchases to the server, the server being controlled by other than the merchant.

8. The system of claim 1, wherein the server is also for providing a set of items available for purchase from the merchant.

9. The system of claim 8, wherein the set of items is stored at the merchant's computer.

10. The system of claim 8, further comprising a catalog server for storing the set of items.

11. A method for facilitating electronic purchases, comprising:
accepting (i) an uploaded multimedia file from an initiator, the multimedia file including at least one of audio, full motion video, image and graphic data, (ii) a personal text message from the initiator, (iii) information identifying at least one responder, (iv) information specifying the date and time when the at least one responder is to be notified of the availability of the multimedia file, and (v) a selection of at least one item available for purchase from a merchant,
notifying, at the specified date and time, the at least one responder of the availability of the uploaded multimedia file, and for sending the personal text message to the responder at the specified date and time,
accepting a purchase order for the selected item, and
providing the purchase order to the merchant.

12. The method of claim 11, wherein the purchase order is from the initiator, and the further comprising sending a purchase confirmation notice to the initiator.

13. The method of claim 11, wherein the purchase order is from the responder, and further comprising sending a purchase confirmation notice to the responder.

14. The method of claim 13, further comprising sending the selection of at least one item to the responder.

15. The method of claim 11, further comprising encoding the uploaded multimedia file into a target format.

16. The method of claim 11, further comprising storing the uploaded multimedia file and providing the uploaded multimedia file to the responder.

17. The method of claim 11, wherein the merchant executes software for outsourcing the facilitating of electronic purchases to a third party, the third party being controlled by other than the merchant.

18. The method of claim 11, further comprising providing a set of items available for purchase from the merchant.

19. The method of claim 18, wherein the set of items is stored at the merchant's computer.

20. The method of claim 18, further comprising storing the set of items.
